(19) United States
(12) Patent Application Publication
(10) Pub. No.: US 2022/0239249 A1
(43) Pub. Date: Jul. 28, 2022

(54) AEROELASTIC STABILIZER

(71) Applicant: ARRAY TECHNOLOGIES, INC., Albuquerque, NM (US)

(72) Inventors: Nikhil Kumar, Albuquerque, NM (US); Todd Andersen, Heber City, UT (US); Lucas Creasy, Scottsdale, AZ (US); Benjamin C. de Fresart, Albuquerque, NM (US)

(21) Appl. No.: 17/649,228

(22) Filed: Jan. 28, 2022

Related U.S. Application Data
(60) Provisional application No. 63/142,959, filed on Jan. 28, 2021.

(51) Int. Cl. H02S 30/10; H02S 20/32

(52) U.S. Cl. CPC H02S 30/10; H02S 20/32

(57) ABSTRACT

A system may include a support column, and a torsion beam connected to the support column and connected to one or more frames circumscribing one or more respective photovoltaic (PV) modules. An angle of orientation of the one or more frames may change based on rotation of the torsion beam. The system may also include an aeroelastic stabilizer associated with an edge of at least one of the frames. The association between the aeroelastic stabilizer and the edge of the at least one of the frames may include the aeroelastic stabilizer being fixedly coupled to the rail. The association between the aeroelastic stabilizer and the edge of the at least one of the frames may include the aeroelastic stabilizer being integrally formed with the rail to which the edge of the at least one of the frames is fixedly coupled.

### CROSS-REFERENCE TO RELATED APPLICATIONS

This application claims the benefit of U.S. Patent Application Ser. No. 63/142,959, filed on Jan. 28, 2021; the disclosure of which is incorporated herein by reference in its entirety.

### TECHNICAL FIELD

The present disclosure relates to use of an aeroelastic stabilizer to disrupt formation of vortices.

### BACKGROUND

Systems of solar panels may include one or more photovoltaic (PV) modules. A PV module may be a photovoltaic cell that capture photons of light energy from the Sun to generate electrical energy. The amount of photons captured by the PV module may depend on the orientation of the PV module with respect to the Sun such that the PV module captures a greater number of photons when the PV module is oriented towards the Sun. PV modules may be mounted in rows on solar trackers that direct an orientation of the PV modules such that the orientation of the PV modules changes throughout a day and the PV modules remain oriented towards the Sun for longer periods of time.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

One or more embodiments of the present disclosure may include a system that may include a support column, and a torsion beam connected to the support column and connected to one or more frames circumscribing one or more respective photovoltaic (PV) modules. An angle of orientation of the one or more frames may change based on rotation of the torsion beam. The system may also include an aeroelastic stabilizer associated with an edge of at least one of the frames.

In some embodiments, the aeroelastic stabilizer provides no structural support for the frames, the one or more PV modules, the torsion beam, or the support column.

In some embodiments, the aeroelastic stabilizer may be oriented perpendicular to a surface of the PV modules.

In some embodiments, the aeroelastic stabilizer may be a continuous sheet coupled to and/or associated with at least two of the frames along a given row of the photovoltaic modules.

In some embodiments, the aeroelastic stabilizer may project in a direction away from and below the one or more rows of photovoltaic modules.

In some embodiments, the aeroelastic stabilizer may interface with more than one edge of a given frame.

In some embodiments, the aeroelastic stabilizer may include aeroelastic tabs positioned along an edge of at least one of the frames with which the aeroelastic stabilizer interfaces and/or is associated.

In some embodiments, the tabs may be tapered.

In some embodiments, the tabs may be positioned at equidistant locations along the edge of the at least one of the frames.

In some embodiments, the association between the aeroelastic stabilizer and the edge of the at least one of the frames includes the aeroelastic stabilizer being integrally formed with the at least one of the frames.

In some embodiments, the association between the aeroelastic stabilizer and the edge of the at least one of the frames may include the aeroelastic stabilizer being fixedly coupled to the edge of the at least one of the frames.

In some embodiments, the system may also include a rail to which the edge of the at least one of the frames is fixedly coupled, the rail supporting a plurality of the one or more PV modules.

In some embodiments, the association between the aeroelastic stabilizer and the edge of the at least one of the frames may include the aeroelastic stabilizer being integrally formed with the rail to which the edge of the at least one of the frames is fixedly coupled.

In some embodiments, the association between the aeroelastic stabilizer and the edge of the at least one of the frames may include the aeroelastic stabilizer being fixedly coupled to the rail.

One or more embodiments of the present disclosure may include a device that includes a photovoltaic (PV) module; and a frame encasing the PV module, where the frame may include an aeroelastic stabilizer integrally formed with the frame. The aeroelastic stabilizer may extend from an edge of the frame perpendicularly away from the PV module.

In some embodiments, the aeroelastic stabilizer may extend away from the PV module towards the ground.

In some embodiments, the aeroelastic stabilizer may include multiple individual tabs extending away from the edge of the frame.

In some embodiments, the aeroelastic stabilizer may include a continuous sheet of material extending away from the edge of the frame.

One or more embodiments of the present disclosure may include a device that includes a rail shaped to support multiple photovoltaic (PV) modules, where the rail may couple the PV modules to a torsion beam. The rail may be fixedly coupled to the torsion beam such that as the torsion beam is rotated, the rail rotates a corresponding amount. The rail may include an aeroelastic stabilizer integrally formed with the rail, where the aeroelastic stabilizer may extend from an edge of the rail perpendicularly away from the PV module.

In some embodiments, the aeroelastic stabilizer may include multiple individual tabs extending away from the edge of the rail.

In some embodiments, the aeroelastic stabilizer may include a continuous sheet of material extending away from the edge of the rail.

In some embodiments, the aeroelastic stabilizer may include a first arm that extends in a first direction parallel with the PV modules and away from a main shaft of the rail, and a second arm that extends in a second direction opposite the first direction and parallel with the PV modules.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example embodiment of a first PV module system including an aeroelastic stabilizer;

FIG. 2A illustrates another example embodiment of a second PV module system including a second embodiment of an aeroelastic stabilizer;

FIG. 2B illustrates a close-up view of the second embodiment of the aeroelastic stabilizer of FIG. 2A;

FIG. 2C illustrates a close-up view of a variation on the second embodiment of the aeroelastic stabilizer of FIG. 2A;

FIG. 2D illustrates a bottom view of one implementation of the aeroelastic stabilizer of FIG. 2A;

FIG. 2E illustrates a bottom view of another implementation of the aeroelastic stabilizer of FIG. 2A;

FIG. 3A illustrates an additional example embodiment of a third PV module system including a third embodiment of an aeroelastic stabilizer;

FIG. 3B illustrates another example embodiment of a fourth PV module system including a fourth embodiment of the aeroelastic stabilizer;

FIG. 3C illustrates another example embodiment of a fifth PV module system including a fifth embodiment of the aeroelastic stabilizer;

FIG. 4 illustrates an example embodiment of a sixth PV module system;

FIGS. 5A-5B illustrate an example embodiment of an aeroelastic stabilizer integrally formed with a frame of a PV module;

FIGS. 6A-6B illustrate another example embodiment of an aeroelastic stabilizer integrally formed with a frame of a PV module;

FIGS. 7A-7B illustrate an example embodiment of an aeroelastic stabilizer fixedly coupled to a frame of a PV module;

FIGS. 8A-8B illustrate another example embodiment of an aeroelastic stabilizer fixedly coupled to a frame of a PV module;

FIGS. 9A-9C illustrate an example embodiment of an aeroelastic stabilizer integrally formed with a rail to which PV modules are coupled;

FIGS. 10A-10C illustrate another example embodiment of an aeroelastic stabilizer integrally formed with a rail to which PV modules are coupled;

FIGS. 11A-11B illustrate an example embodiment of an aeroelastic stabilizer fixedly coupled to a rail to which PV modules are coupled;

FIGS. 12A-12B illustrate another example embodiment of an aeroelastic stabilizer fixedly coupled to a rail to which PV modules are coupled, all in accordance with one or more embodiments of the present disclosure.

### DETAILED DESCRIPTION

The present disclosure relates to, among other things, use of an aeroelastic stabilizer system to interrupt formation of vortices near PV modules. A PV system may be mounted on a single- or dual-axis tracker such that the PV system remains oriented towards the Sun for longer periods of time relative to a PV system not mounted on a tracker. Because a placement of the PV system is fixed, the position of the Sun relative to the PV system changes throughout a given day. The single-axis tracker may rotate the orientation of the PV system along an axis of rotation throughout a given day to reduce an angle of incidence between the PV system and the Sun for an extended period of time.

Rotation of the PV system along the axis of rotation of the tracker may generate an inertial load on the PV system and/or the tracker. The inertial load may cause damage to and/or degradation of the PV system and/or the tracker over time. Other forces or movement of the PV system may also cause damage and/or degradation of the PV system and/or the tracker over time. In some circumstances, the inertial load and/or other loads or forces may be increased due to resonant vibrations experienced by the PV system and/or the tracker. The inertial load and/or other loads or forces may be further increased due to environmental effects, such as formation of vortices of wind along surfaces of the PV system. For example, small wind effects may be generated at the edge of the PV system that may cause shaking, vibrations, jitter, extraneous upward forces, or other increase to the inertial load and/or other loads or forces due to wind forces. In some circumstances, the vortices may even dislodge the frames and/or PV modules from the support structures holding up the PV modules.

The aeroelastic stabilizer system according to one or more embodiments of the present disclosure may reduce the inertial load experienced by the PV system by reducing or eliminating formation of vortices and/or uneven wind loads along edges of the PV system. For example, the aeroelastic stabilizer system may include physical structure(s) taking certain shapes that may disrupt the formation of such vortices along the edges of the PV system. For example, the aeroelastic stabilizer system may include a physical lip or other continuous sheet of material extending away from the edge of the PV modules. As another example, the aeroelastic stabilizer system may include a series of tabs extending away from the PV system. The aeroelastic stabilizer system may improve longevity of the PV system by reducing damage to or degradation of the PV system over time. The aeroelastic stabilizer system may reduce manufacturing costs of PV systems and/or single-axis trackers by reducing the amount of additional hardware required to improve stability of the PV system, such as dampers and springs. In some embodiments, the shape and/or profile of the aeroelastic stabilizers may disrupt the flow and gathering of wind forces to prevent the formation of vortices.

Embodiments of the present disclosure are explained with reference to the accompanying figures.

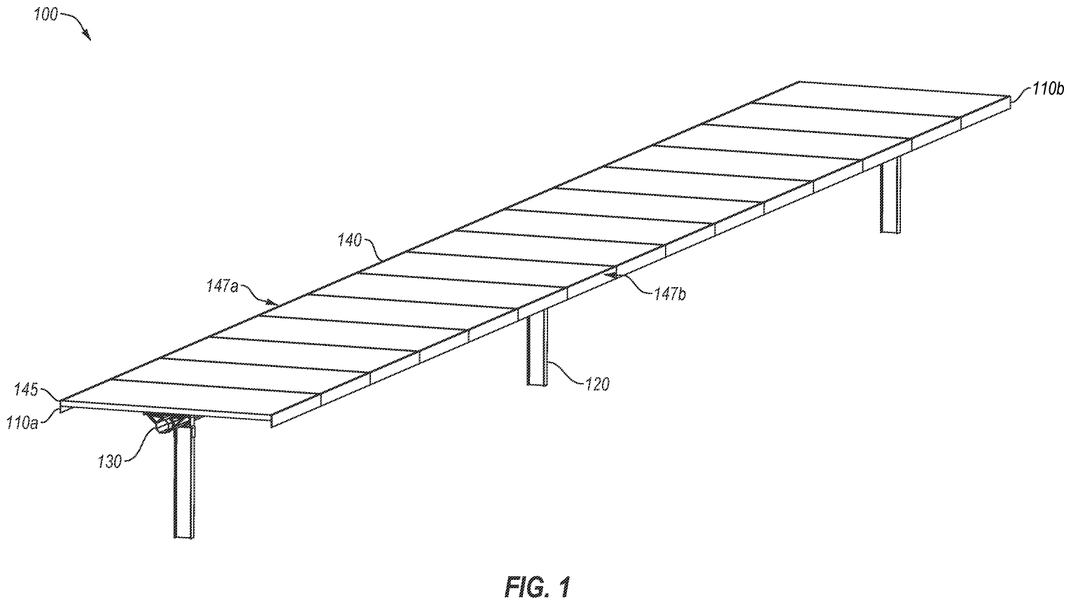

FIG. 1 is a diagram of an example system 100 that illustrates use of aeroelastic stabilizers 110. The system 100 may include one or more aeroelastic stabilizers 110a and 110b (collectively, “aeroelastic stabilizers 110”), one or more support columns 120, a torsion beam 130, one or more rows of PV modules 140, and frames 145 circumscribing each of the PV cells in the one or more rows of PV modules 140.

In some embodiments, the aeroelastic stabilizers 110 may include one or more continuous sheets positioned at one or more edges of the frames 145. The aeroelastic stabilizers 110 may be associated with the one or more edges of the frames 145. For example, the aeroelastic stabilizers 110 may interface with the frames 145 such that the aeroelastic stabilizers 110 are perpendicular to the frames 145. Additionally or alternatively, the aeroelastic stabilizers 110 may be positioned such that the aeroelastic stabilizers 110 are angled away from or toward the torsion beam 130. In such embodiments, the aeroelastic stabilizers 110 may not be perpendicular to the frames 145. Additionally or alternatively, the system 100 may not include a frame 145, and the aeroelastic stabilizers 110 may interface with one or more edges of the row of PV modules 140 themselves. The aeroelastic stabilizers 110 may be positioned such that the aeroelastic stabilizers 110 project in a direction away from the one or more rows of PV modules 140. For example, the aeroelastic stabilizers 110 may project toward the plane representing a base of the support columns 120 (e.g., the ground). In some circumstances, by positioning the aeroelastic stabilizers 110 such that the aeroelastic stabilizers 110 project away from the one or more rows of PV modules 140, the positioning may prevent the aeroelastic stabilizers 110 from obstructing sunlight incident to the PV modules 140 as the aeroelastic stabilizers 110 project away from the PV modules 140.

The support columns 120, the torsion beam 130, the PV modules 140, and/or the frames 145 may experience uneven inertial loads throughout the system 100. Uneven inertial loads may be caused by wind and formation of vortices across the system 100 resulting from resonant vibrations in the system 100 and environmental forces. For example, a first edge 147a of the frames 145 with which the aeroelastic stabilizer 110a interfaces (or is otherwise associated) and/or a second edge 147b of the frames 145 with which the aeroelastic stabilizer 110b interfaces (or is otherwise associated) may experience uneven inertial loads. Positioning the aeroelastic stabilizers 110 at one or more edges of the frames 145 (such as the edges 147a/147b) that may experience uneven inertial loads may interrupt formation of vortices, which may reduce and/or eliminate the uneven inertial loads.

In some embodiments, the aeroelastic stabilizers 110 may or may not be designed to provide structural support to the frames 145, the torsion beam 130, and/or the support column 120. For example, the aeroelastic stabilizers 110 may reduce and/or eliminate the uneven inertial loads due to wind forces without the aeroelastic stabilizers 110 taking any of the structural load on the support columns 120, the torsion beam 130, the PV modules 140, and/or the frames 145.

Modifications, additions, or omissions may be made to the system 100 without departing from the scope of the disclosure. For example, the designations of different elements in the manner described is meant to help explain concepts described herein and is not limiting. Further, the system 100 may include any number of other elements or may be implemented within other systems or contexts than those described.

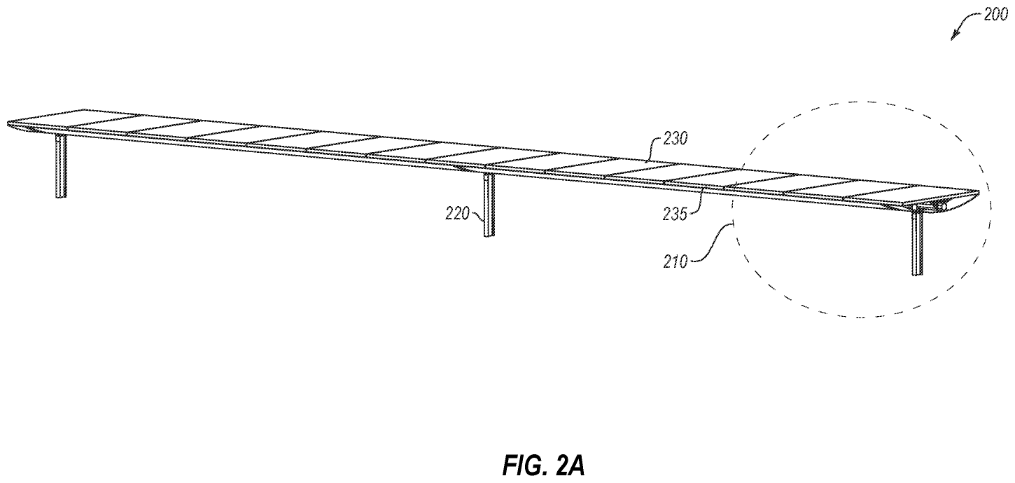

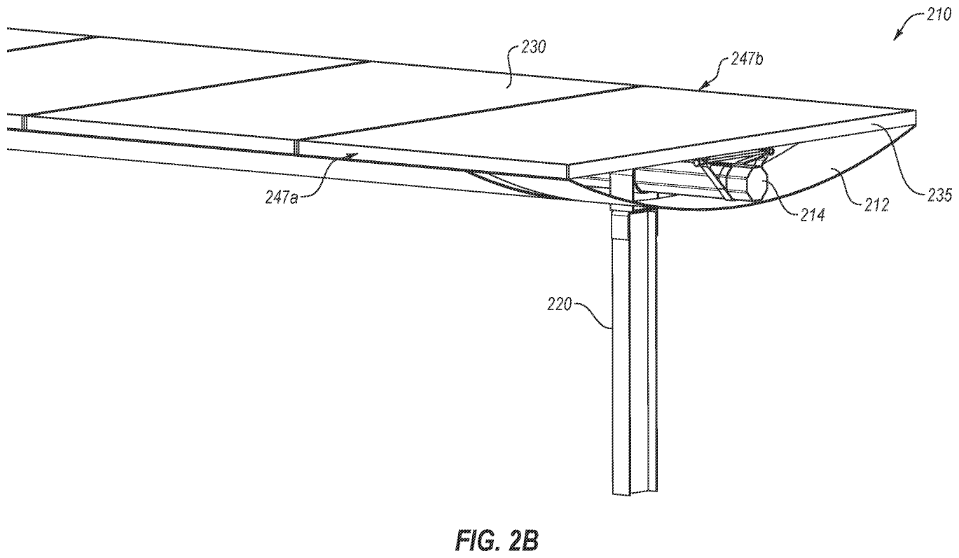

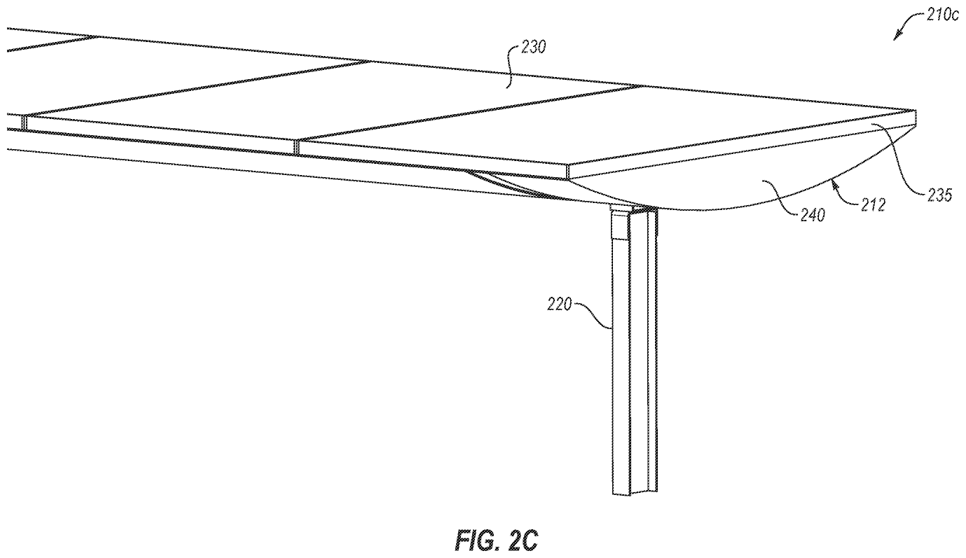

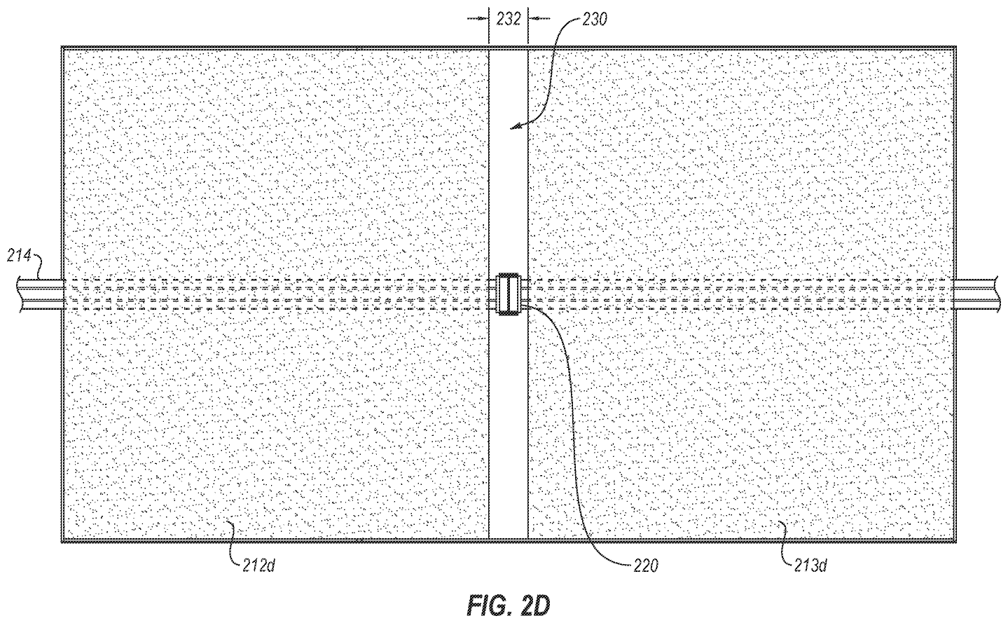

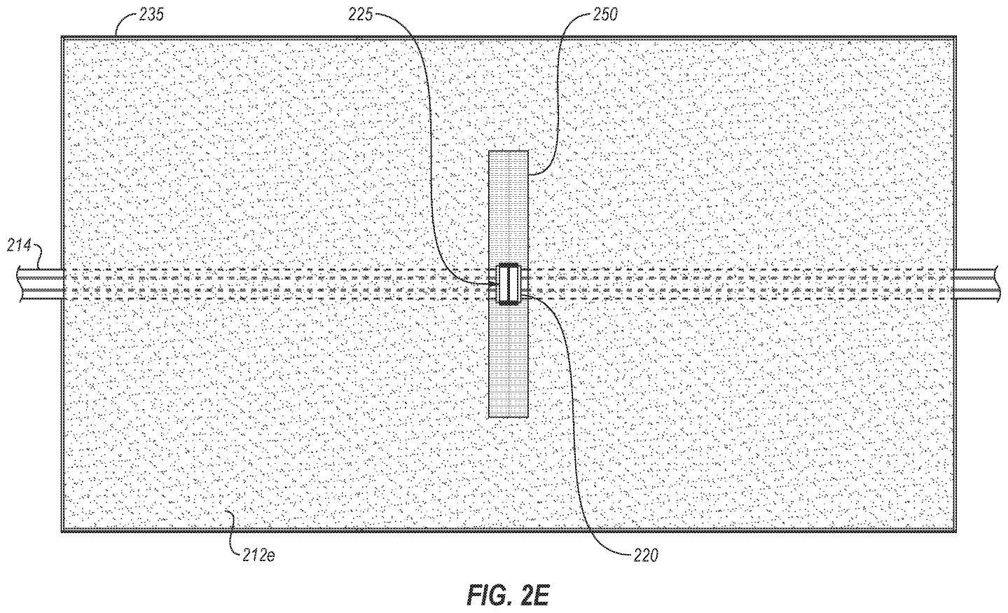

FIG. 2A is a diagram representing an example system 200 that illustrates use of an aeroelastic stabilizer 210. The system 200 may include the aeroelastic stabilizer 210, one or more support beams 220, one or more rows of PV modules 230, and one or more frames 235 circumscribing the PV cells of the one or more rows of PV modules 230.

FIG. 2B is a diagram representing a zoomed-in view of the system 200 focusing on the aeroelastic stabilizer 210. The aeroelastic stabilizer 210 may include an arced stabilizer sheet 212 and a torsion beam 214 positioned between the arced stabilizer sheet 212 and the PV modules 230.

In some embodiments, the aeroelastic stabilizer 210 may be a continuous sheet that interfaces with two or more edges of the frames 235. For example, the aeroelastic stabilizer 210 may interface with a leading edge 247a of the row of PV modules 230, and a trailing edge 247b of the PV modules 230. In such an example, the aeroelastic stabilizer 210 may include the arced stabilizer sheet 212 as a continuous sheet that interfaces with the leading and trailing edges 247a/247b by arcing below the PV modules 230. Additionally or alternatively, the system 200 may not include a frame 235, and the aeroelastic stabilizer 210 may interface with one or more edges of the row of PV modules 230 themselves.

In some embodiments, the aeroelastic stabilizer 210 may be positioned in a way such that sunlight incident to the PV modules 230 is not obstructed. For example, the aeroelastic stabilizer 210 may be an arced stabilizer sheet 212 that connects two non-adjacent edges (such as the edges 247a/247b) of the frames 235 from below the PV modules 230. In such an example, the arced stabilizer sheet 212 may be positioned below the torsion beam 214 such that the torsion beam 214 is positioned above the arced stabilizer sheet 212 and below the PV modules 230. To minimize material costs associated with manufacturing the arced stabilizer sheet 212, the arced stabilizer sheet 212 may be made of a material including a low cost and/or flexible material such as plastic, composite, fibrous material, metal sheeting, or other such materials.

In some embodiments, the aeroelastic stabilizer 210 may span the full length of the row of PV modules 230 (e.g., may be connected along the leading edges/trailing edges 247a/247b of all of the PV modules 230 in a given row). Additionally or alternatively, the aeroelastic stabilizer 210 may span most of, part of, or targeted portions of the row of PV modules 230. In some embodiments, the aeroelastic stabilizer 210 may include cutouts to accommodate mounting hardware such as clamps or other coupling devices, to couple the PV modules 230 to the torsion beam 214. Additionally or alternatively, the aeroelastic stabilizer 210 may include cutouts or gaps to accommodate the torsion beam 214 coupling to the support beam 220. For example, the torsion beam 214 may interface with the support beam 220 at an interface point 225. An example of such cutouts is illustrated in FIG. 2E.

FIG. 2C illustrates a close-up view of a variation on the second embodiment of the aeroelastic stabilizer of FIG. 2A. The arced stabilizer sheet 212, the support beam 220, the PV modules 230, and/or the frames 235 may be comparable or similar to those illustrated in FIGS. 2A/2B.

As illustrated in FIG. 2C, in some embodiments, the aeroelastic stabilizer 210c of FIG. 2C may include a cap 240 for closing the end of a row. The cap 240 may be made of the same material as the arced stabilizer sheet 212 and may enclose the end of a row. Additionally or alternatively, the cap 240 may be made of a more rigid material. For example, the cap 240 may be made of a hard or rigid plastic material while the arced stabilizer sheet 212 may be made of a more pliable material.

By capping the end of the row of PV modules 230, wind forces caused by wind blowing between the PV modules 230 and the arced stabilizer sheet 212 may be avoided. Additionally or alternatively, animals such as squirrels and birds may be prevented from nesting, living, or accessing the space between the PV modules 230 and the arced stabilizer sheet 212.

FIG. 2D illustrates a bottom view of one implementation of the aeroelastic stabilizer 210 of FIG. 2A. The torsion beam 214, the support beam 220, the PV modules 230, and/or the frames 235 may be comparable or similar to those illustrated in FIGS. 2A/2B. The aeroelastic stabilizer may include a first sheet 212d and a second sheet 213d that may operate as the arced stabilizer sheet. For example, the first and second sheets 212d/213d may leave a gap 232 between the sheets 212d/213d to accommodate the interface point 225 at which the torsion beam 214 interfaces with the support beam 220.

By providing the gap 232, the sheets 212d may move with the PV modules 230, frames 235, and/or the torsion beam 214 as a single body. By doing so, the entire space between the sheets 212d/213d and the PV modules 230 may be fully enclosed without seams or interfaces of motion to accommodate, with a tradeoff of the gap 232 being without the sheets 212d/213d to provide the aeroelastic stabilization in the gap 232.

FIG. 2E illustrates a bottom view of another implementation of the aeroelastic stabilizer of FIG. 2A. The torsion beam 214, the support beam 220, and/or the frames 235 may be comparable or similar to those illustrated in FIGS. 2A/2B. The aeroelastic stabilizer may include a single sheet 212e that may operate as the arced stabilizer sheet. For example, the single sheet 212e may extend along a row of PV modules and may include a cutout 216 to accommodate the interface point 225 at which the torsion beam 214 interfaces with the support beam 220.

In some embodiments, the cutout 216 may be sized such that at a maximum tilt of tracking orientation, the interface point 225 is at one end of the cutout 216. For example, at sunrise, the interface point 225 may be at one end of the cutout 216 and at sunset, the interface point 225 may be at the opposite end of the cutout 216 due to rotation of the torsion beam 214 throughout the day.

In some embodiments, the cutout 216 may include a seal 250 that is designed to accommodate motion of the torsion beam and/or the single sheet 212e relative to the support beam 220. For example, the seal 250 may include a bushing, a wiper seal, a compressible material like bristles, or any other material that may fill portions of the cutout 216 but may be displaced by the interface point 225 as the torsion beam 214 is rotated throughout the day.

Modifications, additions, or omissions may be made to the system 200 without departing from the scope of the disclosure. For example, the designations of different elements in the manner described is meant to help explain concepts described herein and is not limiting. Further, the system 200 may include any number of other elements or may be implemented within other systems or contexts than those described.

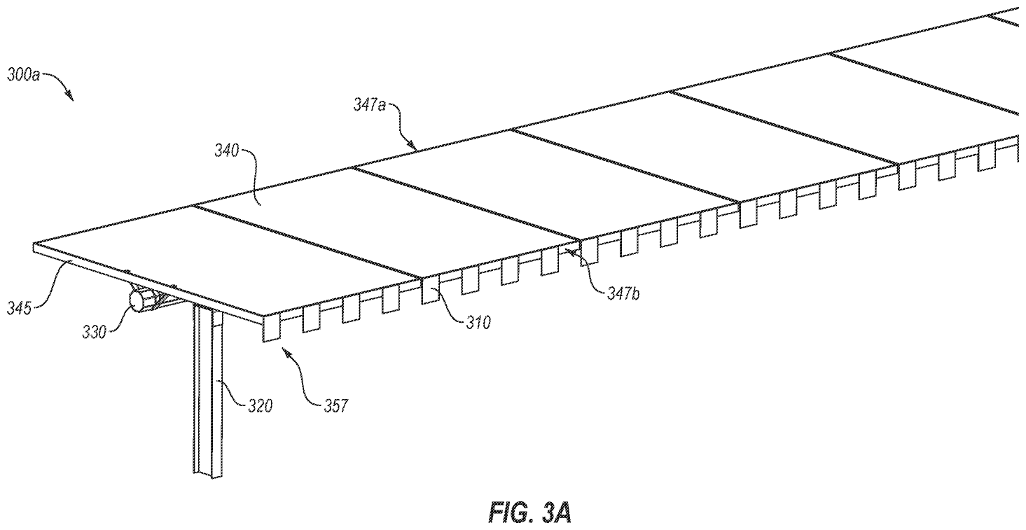

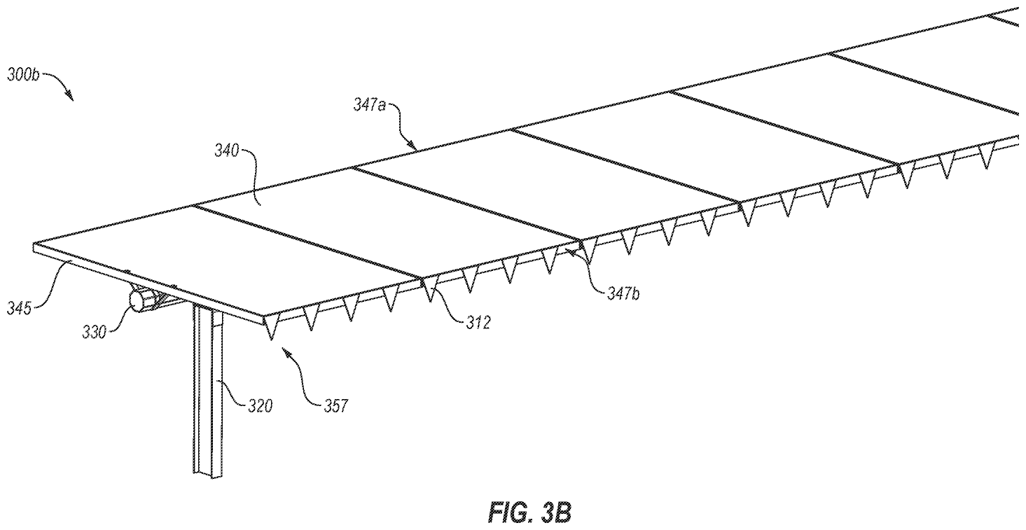

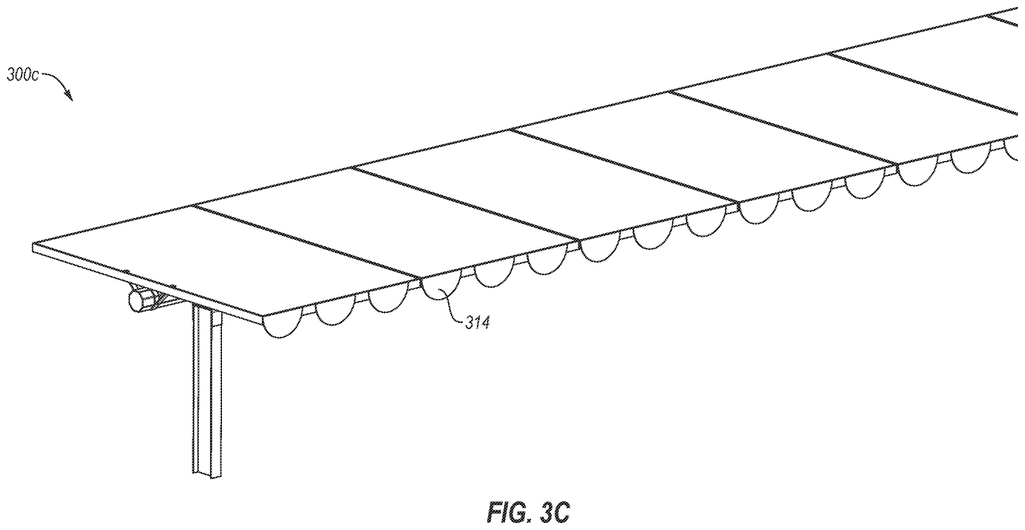

FIG. 3A is a diagram representing an example system 300a that illustrates use of discrete stabilizer tabs 310. The system 300a may include an aeroelastic stabilizer including multiple discrete stabilizer tabs 310, one or more support columns 320, a torsion beam 330, one or more rows of PV modules 340, and frames 345 circumscribing the PV cells of the one or more rows of PV modules 340.

In some embodiments, the discrete stabilizer tabs 310 may be associated with one or more edges 347a/347b of the frames 345. In some embodiments, each stabilizer tab 310 may be positioned an equal distance from neighboring stabilizer tabs 310 along the edges 347a/347b of the frames 345. Additionally or alternatively, the discrete stabilizer tabs 310 may be positioned in a manner that may or may not be equidistant, such as random, varying periodic placement, among other placement arrangements. Additionally or alternatively, the system 300 may not include a frame 345, and the discrete stabilizer tabs 310 may interface with one or more edges 347a/347b of the one or more rows of PV modules 340 themselves.

In some embodiments, the discrete stabilizer tabs 310 may be positioned at one or more predetermined locations along the length of the row of PV modules 340. For example, the discrete stabilizer tabs 310 may be positioned at the periphery or ends (such as the end 357) of the rows of PV modules 340, at which fluctuations in inertial loads may be the greatest.

FIG. 3B is a diagram representing an example system 300b that illustrates use of discrete stabilizer tabs 312. The system 300b may include an aeroelastic stabilizer including multiple discrete stabilizer tabs 312, one or more support columns 320, a torsion beam 330, one or more rows of PV modules 340, and frames 345 circumscribing the PV cells of the one or more rows of PV modules 340. The discrete stabilizer tabs 312 may be tapered such that the discrete stabilizer tabs 312 are triangular in shape.

In some embodiments, the discrete stabilizer tabs 312 may interface with one or more edges 347a/347b of the frames 345. In some embodiments, each stabilizer tab 312 may be positioned an equal distance from neighboring stabilizer tabs 312 along the edges 347a/347b of the frames 345. Additionally or alternatively, the discrete stabilizer tabs 312 may be positioned in a manner that may or may not be equidistant, such as random, varying periodic placement, or other placement patterns or configurations.

In some embodiments, the discrete stabilizer tabs 312 may be positioned at one or more predetermined locations along the length of the row of PV modules 340. For example, the discrete stabilizer tabs 312 may be positioned at the periphery or ends (such as the end 357) of the rows of PV modules 340, at which fluctuations in inertial loads may be the greatest.

FIG. 3C is a diagram representing an example system 300c that illustrates use of discrete stabilizer tabs 314. The system 300c may include an aeroelastic stabilizer including multiple discrete stabilizer tabs 314. In some embodiments, the discrete stabilizer tabs 314 may include one or more flat edges with which an edge of the PV modules and/or a frame may interface and/or a rounded end such that the discrete stabilizer tabs 314 are semi-circular in shape.

Modifications, additions, or omissions may be made to the systems 300a, 300b and/or 300c without departing from the scope of the disclosure. For example, the designations of different elements in the manner described is meant to help explain concepts described herein and is not limiting. Further, the systems 300a, 300b and/or 300c may include any number of other elements or may be implemented within other systems or contexts than those described.

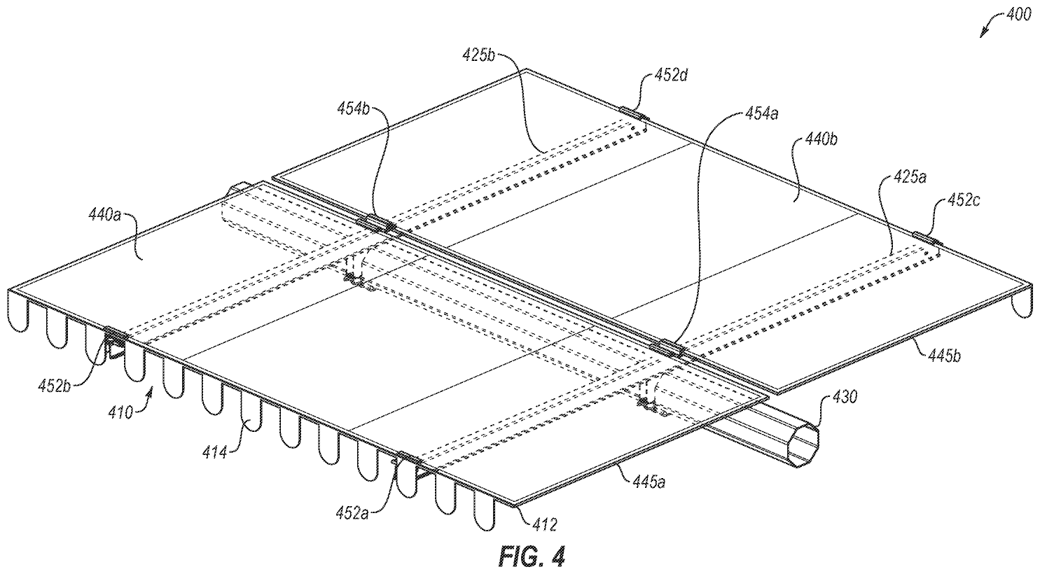

FIG. 4 illustrates an example embodiment of a sixth PV module system 400, in accordance with one or more embodiments of the present disclosure. The PV module system 400 may include a configuration in which multiple PV modules 440 (such as the PV modules 440a/440b) may be mounted on one or more rails 425 (such as rails 425a/426b). An aeroelastic stabilizer 410 may be positioned along one or more ends of the PV modules 440. The PV modules 440a and 440b may be similar or comparable to the PV modules 140 of FIG. 1, frames 445 (such as the frames 445a/445b) of the PV modules may be similar or comparable to the frame 145 of FIG. 1, torsion beam 430 may be similar or comparable to the torsion beam 130 of FIG. 1.

The PV modules 440 may be fixedly coupled to the rail via one or more end brackets 452 (such as the end brackets 452a-452d) and/or one or more mid brackets 454 (such as the mid brackets 454a/454b). For example, the end brackets 452a and 452b and the mid brackets 454a and 454b may be coupled to the rails 425a/425b. The combination of the end brackets 452a/452b and the mid brackets 454a/454b may fixedly couple the PV module 440a to the rails 425a/425b. The rails 425a/425b may be fixedly coupled to the torsion beam 430 such that as the torsion beam 430 is rotated (e.g., to track the position of the sun as it travels across the sky), the rails 425a/425b and in turn the PV module 440a may be rotated a corresponding amount. The PV module 440b may be fixedly coupled to the rails 425a/425b in a similar or comparable manner using the end brackets 452c/452d and the mid brackets 454a and 454b.

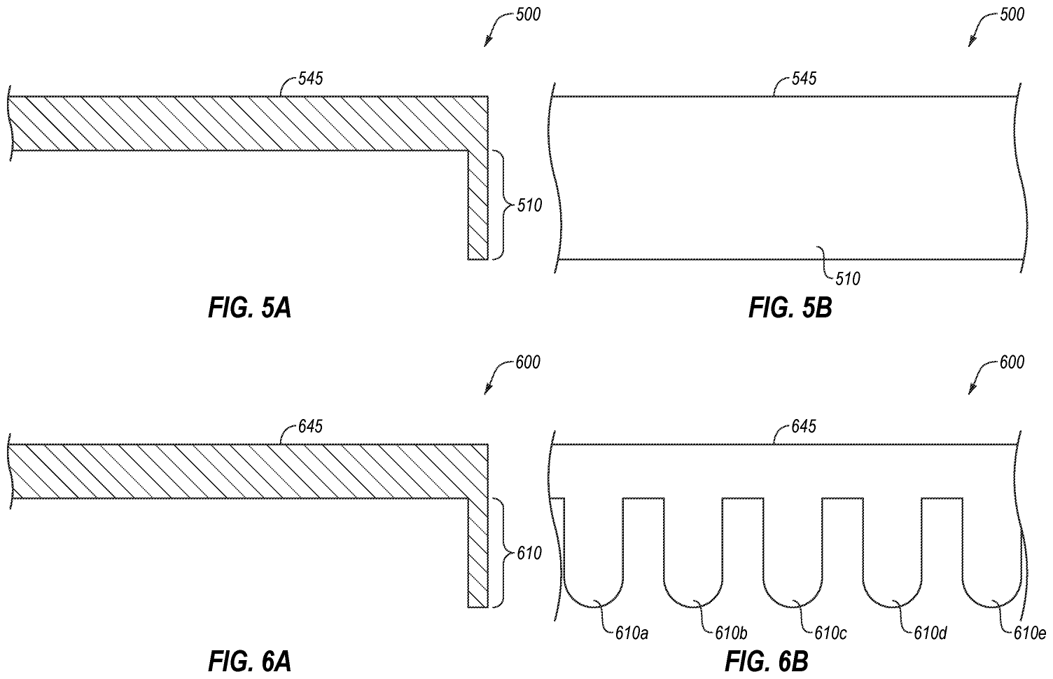

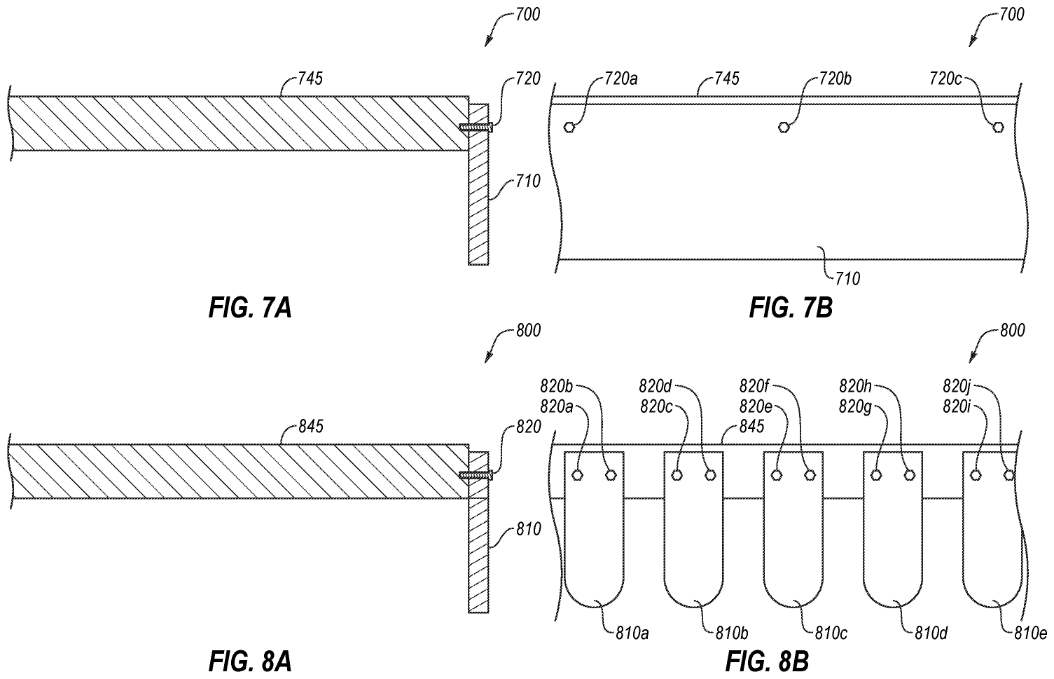

In some embodiments, the aeroelastic stabilizer 410 may include one or more discrete tabs positioned at one or more edges of the frames 445b (such as that illustrated in FIGS. 6A-6B, 8A-8B, 10A-10C, and 12A-12B). Additionally or alternatively, the aeroelastic stabilizer 410 may include one or more continuous sheets positioned at one or more edges of the frames 445b. The aeroelastic stabilizers 110 may be associated with the one or more edges of the frames 145 (such as that illustrated in FIGS. 5A-5B, 7A-7B, 9A-9C, and 11A-11B). In these and other embodiments, the aeroelastic stabilizers 410 may interface with the frame 445a such that the aeroelastic stabilizer 410 is perpendicular to the frame 445a. Additionally or alternatively, the aeroelastic stabilizer 410 may be positioned such that the aeroelastic stabilizer 410 is angled away from or toward the torsion beam 430. In such embodiments, the aeroelastic stabilizer 410 may not be perpendicular to the frame 445a. Additionally or alternatively, the system 400 may not include the frames 445, and the aeroelastic stabilizers 410 may interface with one or more edges of the PV modules 440 themselves. The aeroelastic stabilizer 410 may be positioned such that the aeroelastic stabilizer 410 project in a direction away from the PV module 440a. For example, the aeroelastic stabilizer 410 may project toward the ground. In some circumstances, by positioning the aeroelastic stabilizer 410 such that the aeroelastic stabilizer 410 projects away from the PV module 440a, the positioning may prevent the aeroelastic stabilizer 410 from obstructing sunlight incident to the PV module 440a as the aeroelastic stabilizer 410 projects away from the PV module 440a.

In some embodiments, the aeroelastic stabilizer 410 may include a support 412 and a plurality of tabs 414 that extend away from the support 412. For example, the support 412 may couple to the frame 445a and the tabs 414 may extend away from the support 412. In some embodiments, the support 412 may couple to the rail 425 instead of the frame 445a. In these and other embodiments, a cap or other intermediate component (not shown) may be attached to the end of the rail to which the support 412 may be coupled.

While illustrated with a given profile, it will be appreciated that any of a variety of profiles may be utilized for the tabs 414, some non-limiting examples of which are illustrated in FIGS. 3A-3C.

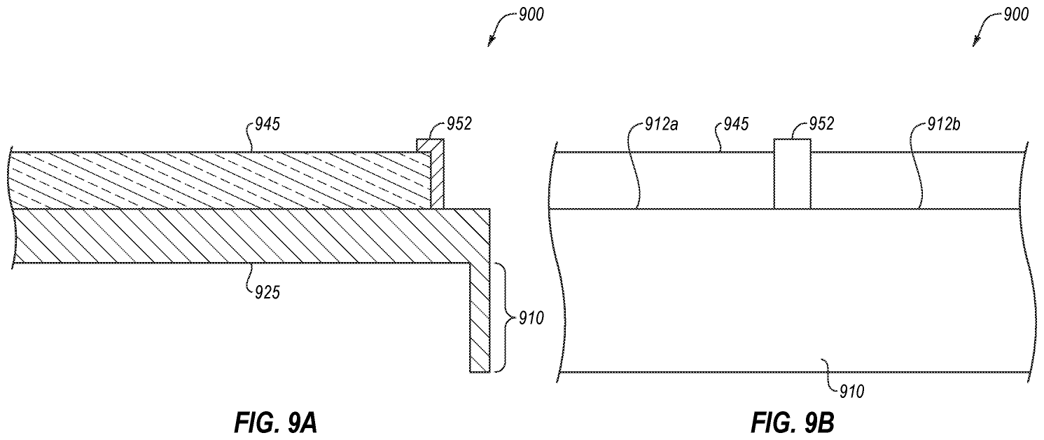

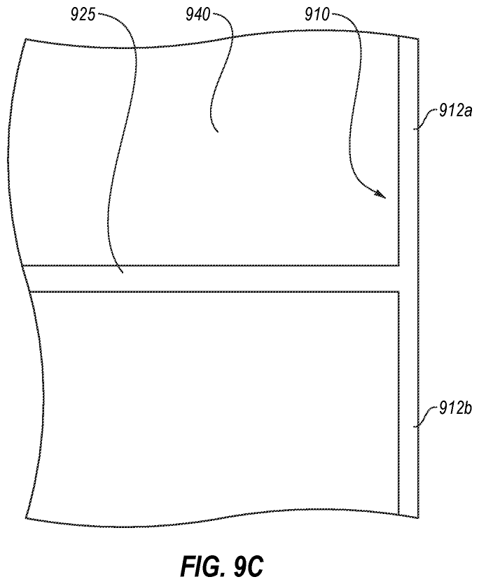

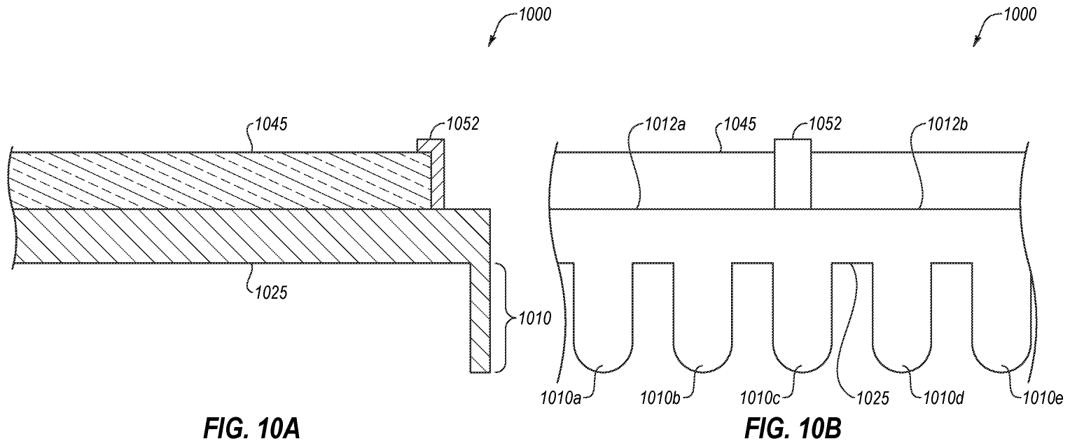

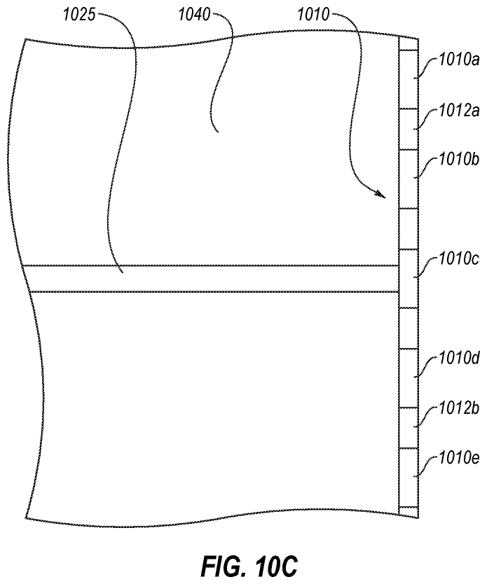

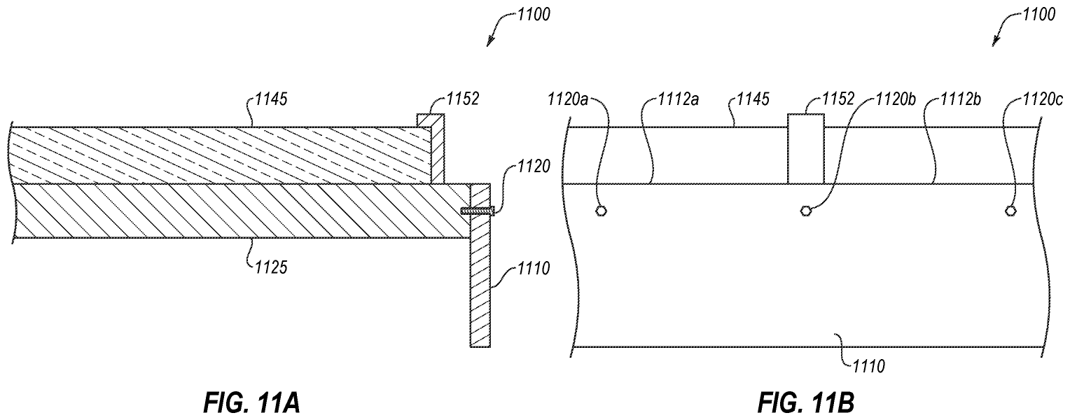

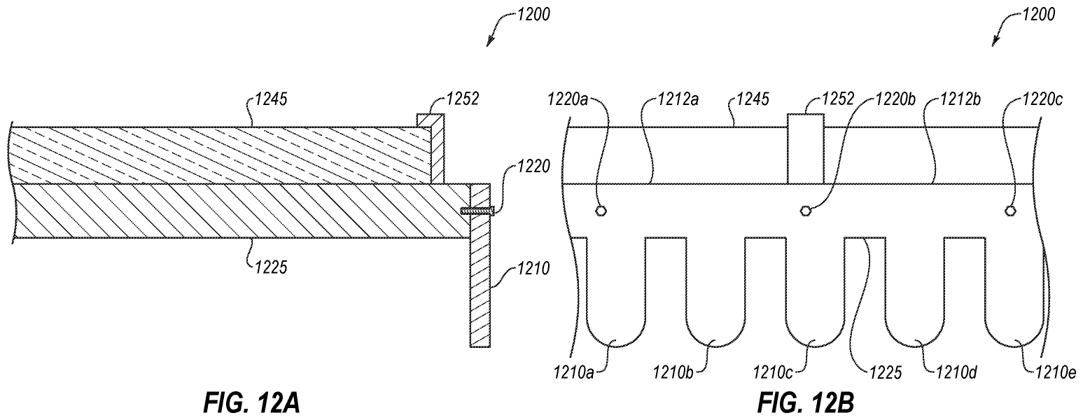

FIGS. 5A-12B illustrate various variations of style of aeroelastic stabilizers with different variations of being integrally formed with a frame or being fixedly coupled to a frame. For example, FIGS. 5A-5B illustrate an embodiment where the aeroelastic stabilizer is implemented as a continuous sheet of material and is integrally formed with the frame of the PV module, FIGS. 6A-6B illustrate an embodiment where the aeroelastic stabilizer is implemented with tabs and is integrally formed with a frame of a PV module, FIGS. 7A-7B illustrate an embodiment where the aeroelastic stabilizer is implemented as a continuous sheet of material and is fixedly coupled to the frame of the PV module, FIGS. 8A-8B illustrate an embodiment where the aeroelastic stabilizer is implemented with tabs and is fixedly coupled to the frame of the PV module, FIGS. 9A-9C illustrate an embodiment where the aeroelastic stabilizer is implemented as a continuous sheet of material and is integrally formed with a rail to which PV modules are coupled, FIGS. 10A-10C illustrate an embodiment where the aeroelastic stabilizer is implemented with tabs and is integrally formed with a rail to which PV modules are coupled, FIGS. 11A-11B illustrate an embodiment where the aeroelastic stabilizer is implemented as a continuous sheet of material and is fixedly coupled to a rail to which PV modules are coupled, and FIGS. 12A-12B illustrate an embodiment where the aeroelastic stabilizer is implemented with tabs and is fixedly coupled to a rail to which PV modules are coupled.

It will be appreciated that for FIGS. 5A-12B, any profile of tab is contemplated. Additionally, the drawings are not to scale and are merely for illustrative purposes. For example, the relative dimension of the length of the aeroelastic stabilizers relative to the frames of PV modules and/or rails is merely for convenience of describing the principles of the present disclosure, and is not intended to be limiting in any way.

FIG. 5A illustrates a side view and FIG. 5B illustrates a front view of a PV module system 500 that includes an aeroelastic stabilizer 510. The aeroelastic stabilizer 510 may be integrally formed with the frame 545 and may extend downwards away from the PV module (not shown) as a continuous sheet of material.

FIG. 6A illustrates a side view and FIG. 6B illustrates a front view of a PV module system 600 that includes an aeroelastic stabilizer 610. The aeroelastic stabilizer 610 may be integrally formed with the frame 645 and may extend downwards away from the PV module (not shown) as a series of tabs 610a-610e.

FIG. 7A illustrates a side view and FIG. 7B illustrates a front view of a PV module system 700 that includes an aeroelastic stabilizer 710. The aeroelastic stabilizer 710 may be fixedly coupled to the frame 745 and may extend downwards away from the PV module (not shown) as a continuous sheet of material. For example, the aeroelastic stabilizer 710 may be attached to the frame 745 using fasteners 720 (such as the fasteners 720a-720c). The fasteners 720a-c may include any type or style of fastener, such as screws, bolts, rivets, among other fasteners.

FIG. 8A illustrates a side view and FIG. 8B illustrates a front view of a PV module system 800 that includes an aeroelastic stabilizer 810. The aeroelastic stabilizer 810 may be fixedly coupled to the frame 845 and may extend downwards away from the PV module (not shown) as a series of tabs 810a-810e. For example, the aeroelastic stabilizer 810 may be attached to the frame 845 using fasteners 820 (such as the fasteners 820a-820j). The fasteners 820a-j may include any type or style of fastener, such as screws, bolts, rivets, among other fasteners. In some embodiments, the aeroelastic stabilizer 810 may include a support from which the tabs 810a-810e may extend, such as that illustrated in FIG. 4.

FIG. 9A illustrates a side view, FIG. 9B illustrates a front view, and FIG. 9C illustrates a bottom view of a PV module system 900 that includes an aeroelastic stabilizer 910. The frame 945 of the PV module may be fixedly coupled to the rail 925 using an end bracket 952. The rail 925 may include a main shaft 927 and two arms 912a/912b extending away from the main shaft 927 at or near the edge of the frame 945 of the PV module 940. The aeroelastic stabilizer 910 may be integrally formed with the rail 925 and may extend downwards away from the main shaft 927 as a continuous sheet of material.

FIG. 10A illustrates a side view, FIG. 10B illustrates a front view, and FIG. 10C illustrates a bottom view of a PV module system 1000 that includes an aeroelastic stabilizer 1010. The frame 1045 of the PV module may be fixedly coupled to the rail 1025 using an end bracket 1052. The rail 1025 may include a main shaft 1027 and two arms 1012a/1012b extending away from the main shaft 1027 at or near the edge of the frame 1045 of the PV module 1040. The aeroelastic stabilizer 1010 may be integrally formed with the rail 1025 and may extend downwards away from the main shaft 1027 as a series of tabs 1010a-1010e.

FIG. 11A illustrates a side view, and FIG. 11B illustrates a front view of a PV module system 1100 that includes an aeroelastic stabilizer 1110. The frame 1145 of the PV module may be fixedly coupled to the rail 1125 using an end bracket 1152. The aeroelastic stabilizer 1110 may be fixedly coupled to the rail 1125 and may extend downwards away from the rail 1125. For example, the aeroelastic stabilizer 1110 may be attached to the rail 1125 using fasteners 1120 (such as the fasteners 1120a/1120b). The fasteners 1120a/1120b may include any type or style of fastener, such as screws, bolts, rivets, among other fasteners.

While illustrated as the aeroelastic stabilizer 1110 being significantly wider than the rail 1125 and coupling to the rail 1125 in the middle, in some embodiments, the aeroelastic stabilizer 1110 may be coupled to the rail 1125 at any point along the aeroelastic stabilizer 1110. Additionally or alternatively, the rail 1125 may include arms at the end of the rail 1125 (such as illustrated in FIG. 9C) and the aeroelastic stabilizer 1110 may couple to the arms at the end of the rail 1125.

FIG. 12A illustrates a side view, and FIG. 12B illustrates a front view of a PV module system 1200 that includes an aeroelastic stabilizer 1210. The frame 1245 of the PV module may be fixedly coupled to the rail 1225 using an end bracket 1252. The aeroelastic stabilizer 1210 may include a support 1205 and a series of tabs 1210a-1210e that may extend downwards away from the support 1205 and are fixedly coupled to the rail 1225. For example, the aeroelastic stabilizer 1210 may be attached to the rail 1225 using fasteners 1220 (such as the fasteners 1220a/1220b). The fasteners 1220a/1220b may include any type or style of fastener, such as screws, bolts, rivets, among other fasteners.

While illustrated as the aeroelastic stabilizer 1210 being significantly wider than the rail 1225 and coupling to the rail 1225 in the middle, in some embodiments, the aeroelastic stabilizer 1210 may be coupled to the rail 1225 at any point along the aeroelastic stabilizer 1210. Additionally or alternatively, the rail 1225 may include arms at the end of the rail 1225 (such as illustrated in FIG. 9C) and the aeroelastic stabilizer 1210 may couple to the arms at the end of the rail 1125. For example, the aeroelastic stabilizer 1210 may include discrete tabs coupled to the arms of the rail 1225.

In some embodiments, any of the aeroelastic stabilizers may be positioned at given locations around a site that includes multiple rows of PV modules. For example, the aeroelastic stabilizers may be disposed along an entire row at either end of the site. As another example, the aeroelastic stabilizers may be disposed along all rows except rows at the edge of a site. As an additional example, the aeroelastic stabilizers may be disposed along all edges of a site and intermittently disposed throughout the site. As another example, the aeroelastic stabilizers may be disposed along every third row, every fifth row, or other such spacing. As an additional example the aeroelastic stabilizers may be positioned along every other frame of a PV module along a given row, along every third frame, along every fourth frame, or other such spacing. In some embodiments, half of every other row may include the aeroelastic stabilizers. While various examples are given, it will be appreciated that any arrangement and configuration of aeroelastic stabilizers at various locations throughout a site are contemplated by the present disclosure.

In some embodiments, rather than a component that is coupled to the frame, it will be appreciated that the aeroelastic stabilizers may be formed as part of the frame. For example, a profile of one or more of the frames encasing the PV cells may include one or more features, protrusions, tabs, or other such features that may function to disturb the formation of vortices. In these and other embodiments, such features, protrusions, tabs, or other such features may or may not provide structural support or structural strength to the frame.

In addition to being part of the frame (such as illustrated in FIGS. 5A-5B and 6A-6B), coupled to the frame (such as illustrated in FIGS. 7A-7B and 8A-8B), part of the rail (such as illustrated in FIGS. 9A-9C and 10A-10C), or coupled to the frail (such as illustrated in FIGS. 11A-11B and 12A-12B), the aeroelastic stabilizer may be coupled to the torsion beam itself. For example, a component may be suspended or project from the torsion beam towards an edge of the frame and may include an aeroelastic stabilizing feature in a similar or comparable manner to the rail.

While described in the context of a single axis tracker with a torsion beam, it will be appreciated that the principles of the present disclosure are equally applicable to fixed systems and/or dual-axis trackers or other configurations of PV module systems. For example, a fixed frame system may include aeroelastic stabilizers along an edge of the PV module frames attached to the fixed frame system. As another example, aeroelastic stabilizers may be disposed on the edge of PV module frames attached to a dual axis tracker system.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A system comprising:
a support column;
a torsion beam connected to the support column and connected to one or more frames circumscribing one or more respective photovoltaic (PV) modules, wherein an angle of orientation of the one or more frames changes based on rotation of the torsion beam; and
an aeroelastic stabilizer associated with an edge of at least one of the frames.

2. The system of claim 1, wherein the aeroelastic stabilizer provides no structural support for the frames, the one or more PV modules, the torsion beam, or the support column.

3. The system of claim 1, wherein the aeroelastic stabilizer is oriented perpendicular to a surface of the PV modules.

4. The system of claim 1, wherein the aeroelastic stabilizer projects in a direction away from and below the PV modules.

5. The system of claim 1, wherein the aeroelastic stabilizer is a continuous sheet associated with at least two of the plurality of PV modules along a row of the PV modules.

6. The system of claim 1, wherein the aeroelastic stabilizer interfaces with more than one edge of a given frame.

7. The system of claim 1, wherein the aeroelastic stabilizer comprises a plurality of tabs positioned along an edge of at least one of the frames with which the aeroelastic stabilizer is associated.

8. The system of claim 7, wherein the tabs are tapered.

9. The system of claim 7, wherein the tabs are positioned at equidistant locations along the edge of the at least one of the frames.

10. The system of claim 1, wherein the association between the aeroelastic stabilizer and the edge of the at least one of the frames includes the aeroelastic stabilizer being integrally formed with the at least one of the frames.

11. The system of claim 1, wherein the association between the aeroelastic stabilizer and the edge of the at least one of the frames includes the aeroelastic stabilizer being fixedly coupled to the edge of the at least one of the frames.

12. The system of claim 1, further comprising a rail to which the edge of the at least one of the frames is fixedly coupled, the rail supporting a plurality of the one or more PV modules.

13. The system of claim 12, wherein the association between the aeroelastic stabilizer and the edge of the at least one of the frames includes the aeroelastic stabilizer being integrally formed with the rail to which the edge of the at least one of the frames is fixedly coupled.

14. The system of claim 12, wherein the association between the aeroelastic stabilizer and the edge of the at least one of the frames includes the aeroelastic stabilizer being fixedly coupled to the rail.

15. A device comprising:
a photovoltaic (PV) module; and
a frame encasing the PV module, the frame including an aeroelastic stabilizer integrally formed with the frame, the aeroelastic stabilizer extending from an edge of the frame perpendicularly away from the PV module.

16. The device of claim 15, wherein the aeroelastic stabilizer extends away from the PV module towards the ground.

17. The device of claim 15, wherein the aeroelastic stabilizer includes a plurality of individual tabs extending away from the edge of the frame.

18. The device of claim 15, wherein the aeroelastic stabilizer includes a continuous sheet of material extending away from the edge of the frame.

19. A device comprising:
a rail shaped to support a plurality of photovoltaic (PV) modules, the rail coupling the plurality of PV modules to a torsion beam, the rail fixedly coupled to the torsion beam such that as the torsion beam is rotated, the rail rotates a corresponding amount,
wherein the rail includes an aeroelastic stabilizer integrally formed with the rail, the aeroelastic stabilizer extending from an edge of the rail perpendicularly away from the PV module.

20. The device of claim 19, wherein the aeroelastic stabilizer includes a plurality of individual tabs extending away from the edge of the rail.

21. The device of claim 19, wherein the aeroelastic stabilizer includes a continuous sheet of material extending away from the edge of the rail.

22. The device of claim 19, wherein the aeroelastic stabilizer includes:
a first arm that extends in a first direction parallel with the PV modules and away from a main shaft of the rail; and
a second arm that extends in a second direction opposite the first direction and parallel with the PV modules.
